(19) United States
(12) Patent Application Publication
(10) Pub. No.: US 2026/0102779 A1
(43) Pub. Date: Apr. 16, 2026

(54) SHOWERHEAD

(71) Applicant: KOHLER CO., Kohler, WI (US)

(72) Inventor: Peter KAJUCH, Brookfield, WI (US)

(73) Assignee: KOHLER CO., Kohler, WI (US)

(21) Appl. No.: 19/345,685

(22) Filed: Sep. 30, 2025

Related U.S. Application Data
(60) Provisional application No. 63/707,559, filed on Oct. 15, 2024.

(51) Int. Cl. B05B 1/18

(52) U.S. Cl. CPC B05B 1/182

(57) ABSTRACT

A high performance, low flow rate showerhead assembly includes a spray plate and a waterway support. The spray plate defines a plurality of openings extending therethrough. The waterway support is coupled to the spray plate. The waterway support defines a central opening and a plurality of channels. The plurality of channels extend away from the central opening in a substantially radial direction. At least one channel of the plurality of channels extend in a region of the spray plate corresponding to a greatest distance between the central opening and an outermost one of the plurality of openings along the spray plate.

### CROSS-REFERENCE TO RELATED APPLICATIONS

This application claims the benefit of, and priority to, U.S. Provisional Patent Application No. 63/707,559, filed Oct. 15, 2024, the entire contents of which are hereby incorporated by reference herein.

### BACKGROUND

The present disclosure relates generally to spray heads including showerheads for directing and distributing a spray of water. More specifically, the present disclosure relates to showerhead assemblies.

### SUMMARY

One embodiment of the present disclosure relates to a showerhead assembly including a spray plate and a waterway support. The spray plate defines a plurality of openings extending therethrough. The waterway support is coupled to the spray plate. The waterway support defines a central opening and a plurality of channels. The plurality of channels extend away from the central opening in a substantially radial direction. At least one channel of the plurality of channels extend in a region of the spray plate corresponding to a greatest distance between the central opening and an outermost one of the plurality of openings along the spray plate.

In some embodiments, the waterway support defines at least a portion an internal waterway that is configured to direct water received through the central opening across the spray plate to the plurality of openings.

In some embodiments, the waterway support includes: a waterway panel; and a plurality of ribs extending from the waterway panel substantially normal to the waterway panel.

In some embodiments, the waterway support includes a waterway panel, and the waterway panel defines a depression in an outer surface thereof that at least partially defines at least one of the plurality of channels.

In some embodiments, the waterway support includes a waterway panel, and an axial distance between the spray plate and the waterway panel at the at least one channel is greater than an average axial distance between the waterway panel and the spray plate.

In some embodiments, the waterway support includes: a waterway panel that defines the at least one channel of the plurality of channels; and a pair of ribs extending from the waterway panel substantially normal to the waterway panel, where the pair of ribs including a first rib and a second rib that extend along opposing sides of the at least one channel.

In some embodiments, the at least one channel of the plurality of channels extends toward a corner region of the spray plate.

In some embodiments, the waterway support further includes substantially linear ribs that extend between adjacent openings of the spray plate.

In some embodiments, the waterway support includes a first boss disposed at a central position across the waterway support, the spray plate includes a second boss configured to nest within the first boss, and the showerhead assembly further includes a fastener configured to couple the first boss to the second boss.

Another embodiment relates to a waterway support for a showerhead assembly. The waterway support includes an inlet connector defining a central opening; and a waterway panel coupled to the inlet connector. The waterway panel defines a plurality of channels extending away from the central opening in a substantially radial direction, and at least one channel of the plurality of channels extends in a region of the waterway panel between the central opening and a corner region of the waterway panel.

In some embodiments, the waterway support further includes a first set of ribs extending from the waterway panel substantially normal to the waterway panel, the first set of ribs including a first rib and a second rib that extend along opposing sides of the at least one channel.

In some embodiments, the first rib and the second rib extends from an edge of the waterway panel at the central opening.

In some embodiments, a length of at least one rib of the first set of ribs is less than a length of the at least one channel.

In some embodiments, the waterway support includes a second set of ribs that extend linearly away from the central opening, and the first set of ribs extend at an angle relative to the second set of ribs.

In some embodiments, the waterway panel defines a depression in an outer surface thereof that at least partially defines at least one of the plurality of channels.

In some embodiments, a distal end of the at least one channel is disposed in the corner region of the waterway panel.

In some embodiments, the waterway support includes a boss disposed at a central position across the waterway panel, and a plurality of extensions that extend radially between the boss and the inlet connector.

Another embodiment relates to a method of manufacturing a showerhead assembly. The method includes coupling a waterway support defining a central opening and a plurality of channels extending away from the central opening a substantially radial direction to a spray plate defining a plurality of openings therethrough such that at least one channel of the plurality of channels extends in a region of the spray plate that corresponds to a greatest distance between the central opening and an outermost one of the plurality of openings along the spray plate.

In some embodiments, the method further includes forming the waterway support by forming a waterway panel defining the central opening and the plurality of channels extending away from the central opening in the substantially radial direction, such that the at least one channel of the plurality of channels extends in a region of the waterway panel between the central opening and a corner region of the waterway panel.

In some embodiments, the method further includes positioning a nozzle mat that includes a plurality of nozzles between the waterway support and the spray plate, wherein coupling the waterway support to the spray plate includes engaging ribs of the waterway support that extend from edges of the at least one channel with the nozzle mat.

### BRIEF DESCRIPTION OF THE FIGURES

FIG. 1 is a perspective view of a showerhead assembly, according to an embodiment.

FIG. 2 is a bottom view of the showerhead assembly of FIG. 1, showing a nozzle pattern of the showerhead assembly, according to an embodiment.

FIG. 3 is an exploded perspective view of the showerhead assembly of FIG. 1.

FIG. 4 is a side cross-sectional view of the showerhead assembly of FIG. 1.

FIG. 5 is a bottom view of a waterway support that can be used in the showerhead assembly of FIG. 1, according to an embodiment.

FIG. 6 is a top cross-sectional view of the showerhead assembly of FIG. 1, taken through ribs of a waterway support.

FIG. 7A is a side cross-sectional view of a showerhead assembly, according to another embodiment.

FIG. 7B is a bottom view of a waterway support that can be used in the showerhead assembly of FIG. 7A, according to an embodiment.

FIG. 8 is a flow diagram of a method of making a showerhead assembly, according to an embodiment.

### DETAILED DESCRIPTION

Existing showerheads provide water to a user to facilitate cleaning and warming of a user's body. The showerheads are typically designed to provide flowrates of 1.8 gallons per minute, 2.5 gallons per minute, or greater, which balances water usage with the flowrates need to provide adequate coverage, wetting, and rinsing functions during showering (e.g., to enhance user comfort (e.g., provide warming of the user's body, etc.) while also facilitating removal of soap, shampoo, and debris, etc.). Reducing the flowrate of water from existing showerheads below these values can reduce user satisfaction, and can result in longer showering times to ensure that the user's body is fully cleaned.

Referring generally to the figures, a showerhead assembly is shown that is configured to reduce overall water consumption without significantly reducing showering performance (e.g., coverage, wetting, and rinsing functions, etc.). The showerhead assembly includes a unique combination of features, including passive air induction to inflate the water droplets and a waterway structure that improves distribution of water across the showerhead to make less water feel like more.

In at least one embodiment, the waterway structure defines multiple channels that are structured to direct water from the inlet of the showerhead assembly and to outer regions of the spray plate. In some embodiments, the channels are defined by recessed areas in the waterway structure that extend from a central opening of the waterway structure. The channels reduce the pressure drop between the inlet and outer perimeter regions of the interior waterway (e.g., between the inlet and corner regions, or other regions/areas farthest from the inlet), which can improve flow distribution across the inlet waterway, and result in a more uniform water delivery pressure across the spray face.

The showerhead assembly can also include an arrangement of nozzles that improves spray coverage while providing regions of greater water concentration. In some embodiments, the showerhead assembly can reduce the overall flowrate by 50% or more as compared to existing showerhead designs (e.g., to flowrates as low as 1.5 gallon per minute, 1 gallon per minute, etc.).

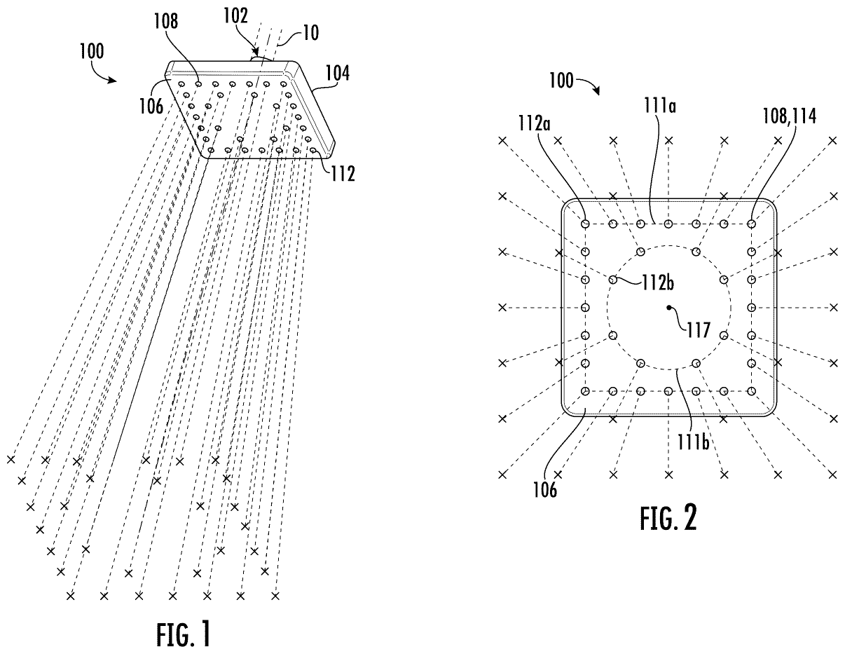

Referring to FIGS. 1-3, a showerhead assembly 100 is shown, according to an embodiment. The showerhead assembly 100 includes an inlet assembly 102, a rear cover 104, a spray plate 106, a nozzle mat 108, and a waterway support 110. In other embodiments, the showerhead assembly 100 may include additional, fewer, and/or different components.

The showerhead assembly 100 (e.g., the inlet assembly 102, etc.) is structured to receive water from a residential and/or commercial water supply line, shown as a supply 10. The showerhead assembly 100 is structured to meter the flowrate that is delivered from the supply 10 into a bathing environment, such as a shower enclosure.

Although the various embodiments described herein are directed to showerheads for use in shower enclosures and/or bathing environments, it should be appreciated that the same or similar designs may also be used in spray head assemblies for other applications (e.g., hand showers, faucets, etc.) without departing from the inventive principles described herein.

The spray plate 106 defines a plurality of openings, shown as openings 112, extending therethrough. The showerhead assembly 100 is structured to distribute water through a plurality of openings, shown as openings 112, in the spray plate 106 (e.g., a forward cover, a forward housing, a spray panel, etc.). The spray plate 106 is a rectangular spray plate having a rectangular cross-section when view normal to a central axis 117 of the spray plate 106. In some embodiments, the shape of the spray plate 106 may be different (e.g., circular, elliptical, etc.). Referring to FIG. 2, the showerhead assembly 100 also includes a plurality of nozzles, shown as nozzles 114, that extend through the openings 112 in the spray plate 106. In some embodiments, the nozzles 114 are formed as part of a nozzle mat 108 of the showerhead assembly 100, as will be further described.

The openings 112 and nozzles 114 are arranged along the spray plate 106 to improve spray coverage (e.g., an area over which the spray is distributed within the shower enclosure), while also providing areas of increased water concentration. In the embodiment of FIG. 2, the openings 112 (and the nozzles 114) are separated into two sets of openings including a first set of openings 112a and a second set of openings 112b. The first set of openings 112a and the second set of openings 112b are arranged in different profiles (e.g., an outer rectangular profile with openings along a perimeter of a rectangular shape and an inner circular profile with openings along a perimeter of a circular shape, etc.) along the spray plate 106, shown as a first profile 111a and a second profile 111b, respectively. The first profile 111a circumscribes the second profile 111b. In other embodiments, the relative position of the first profile 111a and the second profile 111b may be different. The arrangement of openings into two different profiles along the spray plate 106 can increase cleaning performance and improve overall coverage for a user as compared to other nozzle/opening arrangements.

It should be appreciated that the size, number, and position of the openings 112 and the nozzles 114 (and/or active vs. inactive nozzles) along the spray plate 106 may be different in various embodiments.

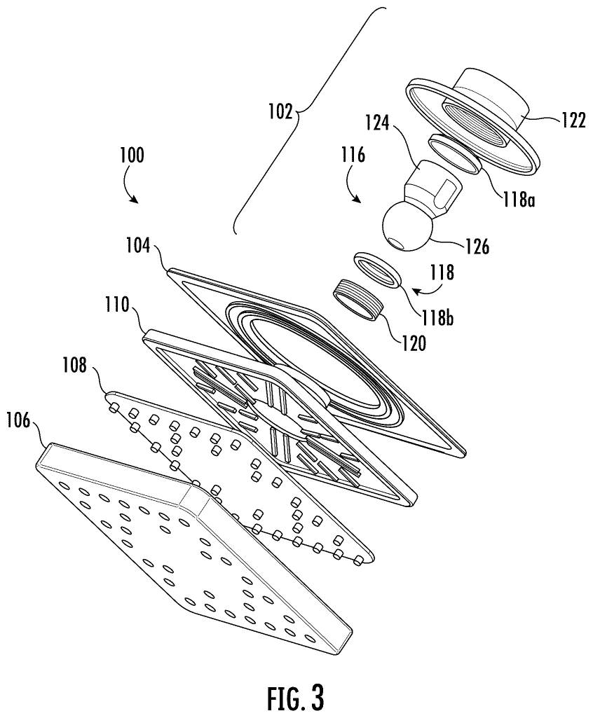

Referring to FIG. 3, the inlet assembly 102 is configured to secure the showerhead assembly 100 to the supply 10 (e.g., a water supply line as shown in FIG. 1, etc.). The inlet assembly 102 is also configured to aerate (e.g., introduce air into) the water entering the showerhead assembly 100, which can inflate and expand the water droplets generated by the showerhead assembly 100.

The inlet assembly 102 includes a ball joint connector 116; a ball joint packing 118, including an upper packing member 118a and a lower packing member 118b; a ball joint spring 120; and a ball joint cover 122.

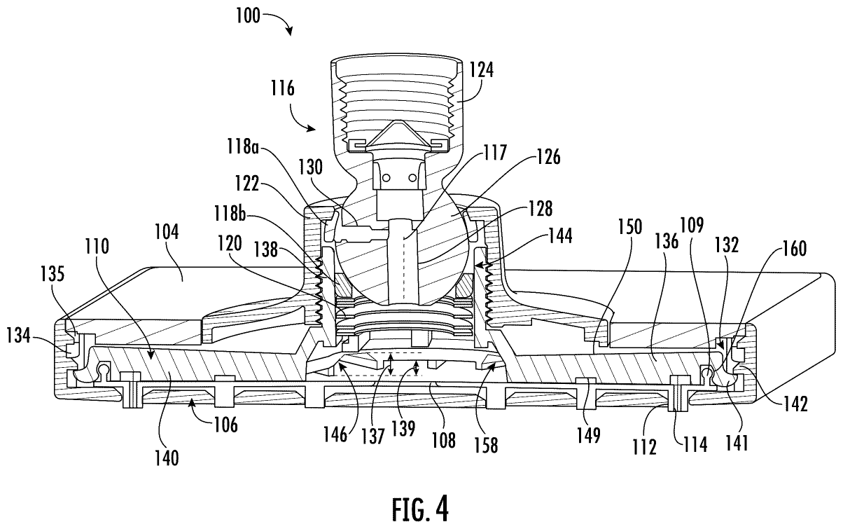

The ball joint connector 116 is threadably engaged with the supply 10 and includes a threaded inlet portion 124, and outlet portion 126 which is generally ball-shaped (e.g., spherical, etc.). Referring to FIG. 4, the outlet portion 126 defines an internal passageway 128 extending axially therethrough, and an air inlet port 130 extending radially away from the internal passageway 128 and through an outer surface of the outlet portion 126. The internal passageway 128 also includes an orifice and/or area of reduced cross-section adjacent to and immediately upstream of a location at which the air inlet port 130 intersects the internal passageway 128. Together, the internal passageway 128 and the air inlet port 130 define a venturi that is structured to pull ambient air into the internal passageway 128 and into the water entering the ball joint connector 116.

Referring to FIG. 4, the air inlet port 130 is disposed in an intermediate axial position along the outlet portion 126 that is disposed axially between the upper packing member 118a and the lower packing member 118b (as well as the ball joint cover 122) when the ball joint connector 116 is fully installed onto the showerhead assembly 100.

The ball joint spring 120 extends between the lower packing member 118b and the waterway support 110 and maintains the lower packing member 118b in compression against the outlet portion 126 of the ball joint connector 116. The ball joint cover 122 is threadably engaged with the waterway support 110 and secures a lower end of the ball joint spring 120 in position relative to the outlet portion 126 of the ball joint connector 116.

The rear cover 104 (e.g., rear panel, rear housing, etc.) is coupled to the spray plate 106 and together with the spray plate 106 defines an outer housing of the showerhead assembly 100. The rear cover 104 and the spray plate 106 together define an internal cavity 132. In the embodiment of FIG. 4, the rear cover 104 includes a plurality of clips, shown as a first set of clips 134, disposed along a perimeter of the rear cover 104 that are structured to clip or otherwise latch onto a first set of ledges 135 of the spray plate 106 that extend inwardly from an outer perimeter wall of the spray plate 106. Such an arrangement conceals the first set of clips 134 from view external to the showerhead assembly 100. In other embodiments, the rear cover 104 may be coupled to the spray plate 106 using mechanical fasteners that are accessible from outside of the internal cavity 132, and/or may be permanently affixed to the spray plate 106 (e.g., by welding, etc.).

The waterway support 110 (e.g., waterway body, etc.) is disposed within the internal cavity 132 between the spray plate 106 and the rear cover 104. The waterway support 110 is configured to distribute water across the spray plate 106 (e.g., the nozzle mat 108, etc.) to produce a more uniform spray pattern. In some embodiments, the waterway support 110 is also configured to secure the inlet assembly 102 (e.g., the ball joint cover 122) to the rear cover 104 and the spray plate 106.

The waterway support 110 includes an inlet connector 138 defining a central opening and a waterway panel 136 coupled to the inlet connector 138. In some embodiments, and as will be further described, the waterway panel 136 defines a plurality of channels, shown as channels 158, extending away from the central opening in a substantially radial direction. In some embodiments, at least one channel of the plurality of channels extends in a region of the waterway panel between the central opening and a corner region 145 of the waterway panel. In some embodiments, the waterway support 110 also includes a plurality of flow directing members (e.g., extension pieces, etc.), shown as ribs 140, as will be further described. In other embodiments, the waterway support 110 may include additional, fewer, and/or different elements.

In the embodiment of FIG. 4, the waterway panel 136 extends from and is coupled to the inlet connector 138. In some embodiments, the waterway panel 136 is substantially planar. The waterway panel 136 is oriented substantially parallel to the spray plate 106 and extends across the spray plate 106. Referring to FIG. 4, the waterway support 110 also includes a plurality of clips, shown as waterway clips 141, disposed along an outer perimeter of the waterway panel 136. The waterway clips 141 that are structured to clip or otherwise latch onto a second set of ledges 142 of the spray plate 106 that extend inwardly from an outer perimeter wall of the spray plate 106 to secure the waterway panel 136 to the spray plate 106.

As shown in FIG. 4, the second set of ledges 142 are disposed at an intermediate position along the wall of the spray plate 106, axially between (i) the first set of clips 134 and/or the first set of ledges 135 and (ii) a spray face that defines the openings 112. Such an arrangement conceals the waterway clips 141 from view from outside of the internal cavity 132. In other embodiments, the waterway support 110 may be coupled to the spray plate 106 using mechanical fasteners that are accessible from outside of the internal cavity 132, or may be permanently affixed to the spray plate 106 (e.g., by welding, etc.). In the embodiment of FIG. 4, the location of the first set of clips 134 and the waterway clips 141 (and corresponding ledges) determine the position of the waterway panel 136 within the showerhead assembly 100.

The inlet connector 138 is structured to couple the waterway panel 136 to the ball joint cover 122. In some embodiments, as shown in FIG. 4, the inlet connector 138 is a cylindrical protrusion that is coupled to the waterway panel 136 at a central position along the waterway panel 136. In the embodiment of FIG. 4, the inlet connector 138 is threadably engaged with the ball joint cover 122. The inlet connector 138 defines a central opening 144 that is configured to deliver water from the ball joint connector 116 toward the spray plate 106. The central opening 144 extends axially through the inlet connector 138 and through the waterway panel 136 (such that the waterway panel 136 defines at least a portion of the central opening 144 in some embodiments).

The waterway support 110 defines at least a portion of an internal waterway 146 that is configured to direct water received through the central opening 144 across the spray plate 106 (e.g., the nozzle mat 108). The waterway support 110 has a first side 149 that faces axially toward the spray plate 106, and a second side 150 that faces axially away from the spray plate 106. In the embodiment of FIG. 4, the waterway support 110 is structured to engage the nozzle mat 108 on the first side 149 of the waterway support 110. The waterway support 110 (e.g., the first side 149) and the nozzle mat 108 together define the internal waterway 146.

As shown in FIG. 4, the ribs 140 are structured to support the nozzle mat 108 along an axial direction, which can help maintain the position of the nozzles with respect to the spray plate (e.g., so that the nozzles remain protruding through the spray plate 106 when being cleaned of scale buildup, etc.). Referring to FIG. 5, the ribs 140 extend from the waterway panel 136 substantially normal to the waterway panel 136. In some embodiments, the ribs 140 are elongated extensions (e.g., tabs, fins, etc.) that extend along the waterway panel 136 in a substantially radial direction away from the central opening 144. In some embodiments, the ribs 140 are also structured to guide the flow of water along a substantially radial direction relative to the central axis of the waterway support 110 (e.g., the central axis 117) toward an outer perimeter portion of the spray plate 106.

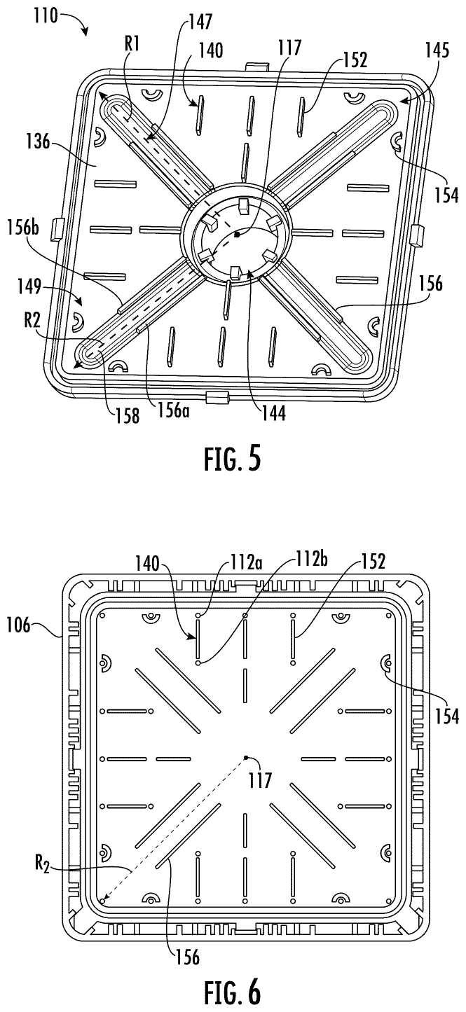

Referring to FIG. 6, the ribs 140 include a first set of ribs 152, a second set of ribs 154, and a third set of ribs 156. The first set of ribs 152 are spaced apart from one another in multiple sections of approximately equal size across the first side 149 of the waterway panel 136 (see also FIG. 5). The first set of ribs 152 include linear ribs that extend linearly away from the central opening 144. The first set of ribs 152 also includes ribs that extend between adjacent openings (e.g., one of the first set of openings 112a and one of the second set of openings 112b, etc.) of the spray plate 106. The first set of ribs 152 extend parallel to one another. Such an arrangement can help to reduce flow along a circumferential direction relative to the central axis 117.

The second set of ribs 154 support the nozzles within openings of the spray plate 106 along an outer perimeter region of the spray plate 106. The second set of ribs 154 includes curved ribs disposed adjacent to respective ones of the openings 112 (e.g., respective ones of the first set of openings 112a) along an outer perimeter region of the spray plate 106. In the embodiment of FIG. 6, the second set of ribs 154 are disposed around openings that are adjacent to (e.g., nearest) corner openings at the corner regions of the showerhead assembly 100. At least one rib of the second set of ribs 154 extends along an outer perimeter portion of the respective one of the openings 112. In the embodiment of FIG. 6, the at least one rib extends across a 180° portion of the respective one of the openings 112, and along a side of the opening that is opposite from an outer perimeter edge of the waterway support 110.

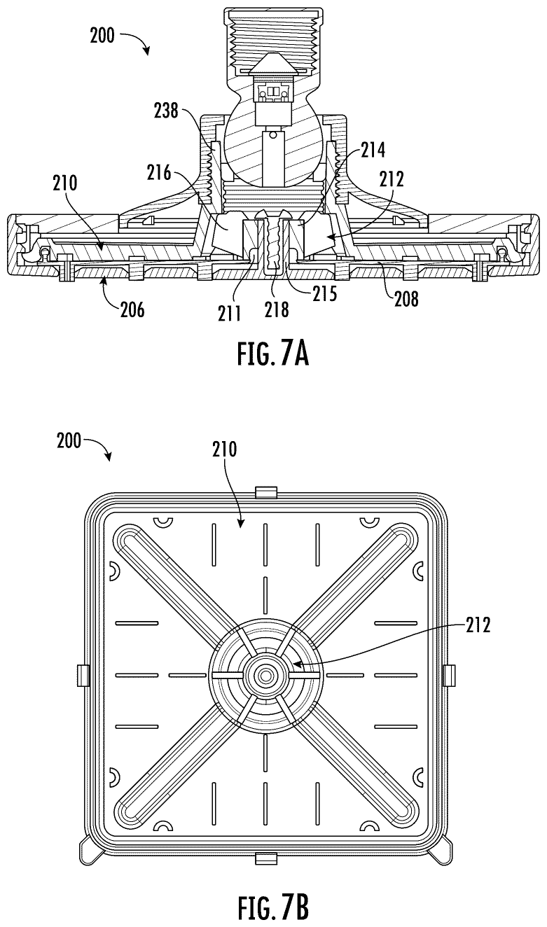

The third set of ribs 156 are structured to direct the flow of water through the channels 158 of the waterway support 110. The third set of ribs 156 extend at an angle relative to the first set of ribs 152. In the embodiment of FIG. 6 and FIGS. 7A and 7B, the third set of ribs 156 are arranged in pairs on either side of a respective one of the channels 158. The third set of ribs 156 extends diagonally across a region of the waterway panel 136 corresponding to a greatest distance R1 between the central opening 144 and an outer perimeter of the waterway panel 136 (e.g., along an area corresponding to the greatest/largest radius of the waterway panel 136, from the central opening 144 toward a corner region of the waterway panel 136). Referring to FIG. 5, at least one pair of ribs includes a first rib 156a that extends along a first edge of a respective one of the channels 158, and a second rib 156b that extends along a second edge of the respective one of the channels 158 that opposes the first edge.

The first rib 156a and the second rib 156b extend from the central opening 144 substantially parallel to a respective one of the channels 158. In the embodiment of FIGS. 6-7, a length of at least one rib of the pair of ribs (e.g., each rib, etc.) along the radial direction is less than a length of the channels 158, which can reduce material requirements and allow flow from the channels 158 to distribute across multiple ones of the outermost openings. In some embodiments, each pair of ribs extends to (e.g., extends radially to) the innermost set of openings along the spray plate 106. In some embodiments, each pair of ribs extends radially past the innermost set of openings. Such an arrangement can improve flow uniformity across the spray plate 106 between the inner and outer sets of openings. In other embodiments, the size and/or location of the third set of ribs 156 may be different.

Referring again to FIG. 5, the waterway support 110 (e.g., the waterway panel 136) defines a plurality of channels, shown as channels 158, on the first side 149 of the waterway support 110. In some embodiments, the rear cover 104 defines at least one of the channels 158 (e.g., the rear cover 104 defines at least a portion of the waterway support 110). The channels 158 extend from the central opening 144 along a substantially radial direction relative to the central axis 117. In some embodiments, at least one of the channels 158 extends across a region of the waterway panel 136 corresponding to a greatest distance R1 between the central opening 144 and an outer perimeter of the waterway panel 136 (e.g., along an area corresponding to the greatest/largest radius of the waterway panel 136).

Referring to FIG. 5 (see also FIG. 6), at least one of the channels 158 extends across a region corresponding to a greatest radial distance R2 between the central axis 117 and the outermost opening along the spray plate 106. In the embodiment of FIG. 5, at least one of the channels 158 extends from the central opening 144 toward a corner region 145 and/or toward a corner opening disposed in the corner region 145 of the spray plate 106 (e.g., an opening of the spray plate 106 that is located farthest from the central opening 144 and/or the central axis 117), such that a distal end of the at least one channel is disposed within the corner region, which can increase flow distribution and performance. In some embodiments, at least one of the channels 158 terminate before reaching the corner opening. In other embodiments, the channels 158 extend at least partially across the corner openings.

As shown in FIG. 5, at least one of the channels 158 is a depression (e.g., a groove, etc.) in the waterway panel 136 that extends from the central opening 144. In such embodiments, an axial distance 137 between the spray plate 106 and waterway panel 136 at the channels 158, relative to the central axis 117, may be greater than an average axial distance 139 (e.g., spacing) between the waterway panel 136 and the spray plate 106. In some embodiments, the channels 158 have a substantially “U” shaped cross-section when viewed normal to the central axis 117. In other embodiments, the cross-sectional shape of the channels 158 may be different. For example, the channels 158 may be straight sided channels having a rectangular cross-sectional shape. In other embodiments, the channels 158 may be tapered having a triangular cross-sectional shape or another cross-sectional shape.

Referring again to FIG. 4, the nozzle mat 108 defines the nozzles 114 of the showerhead assembly 100 that extend through openings 112 along the spray plate 106. The nozzle mat 108 is disposed between the waterway support 110 and the spray plate 106. The waterway support 110 defines at least a portion of an internal waterway 146 that is configured to direct water received through the central opening 144 across the spray plate 106 to the openings 112. The waterway support 110 is engageable with the nozzle mat 108 (e.g., a rear surface of the nozzle mat 108 that faces away from the spray plate 106) to define the internal waterway 146 therebetween.

In some embodiments, the nozzle mat 108 is made from a flexible material (e.g., an elastomer) that has greater flexibility as compared to the waterway support 110. For example, the nozzle mat 108 may be made from silicone or a soft plastic material. In the embodiment of FIG. 4, the third set of ribs 156 of the waterway support 110 are sealingly engaged with the nozzle mat 108 to define a plurality of waterway passages that extend outwardly from the central opening 144 of the waterway support 110. The nozzle mat 108 also includes a seal member 109 disposed along an outer perimeter of the nozzle mat 108 and extending normal to the rear surface of the nozzle mat 108 away from the spray plate 106. The waterway support 110 (e.g., the waterway panel 136) defines a slot 160 (e.g., a groove, etc.) extending along a perimeter thereof that is structured to sealingly engage the seal member 109 to prevent water from leaking out of the internal waterway 146. The seal member 109 sealingly engages the waterway support 110 (e.g., the waterway panel 136) to define a spray chamber (e.g., the internal waterway 146) therebetween.

Referring to FIGS. 7A and 7B, another embodiment of a showerhead assembly 200 is shown. The showerhead assembly 200 is similar to the showerhead assembly 100 described with reference to FIGS. 1-6 and further includes a central support 212 that is structured to support a central area along the spray plate 206 in compression against the nozzle mat 208. In the embodiment of FIG. 7A, the central support 212 includes a first boss 214 that is defined by a waterway support 210 of the showerhead assembly 100. The first boss 214 is a hollow cylindrical extension that is coupled to other portions of the waterway support 210 by a plurality of extensions 216 (e.g., ribs, etc.) that extend radially between the first boss 214 and an inlet connector 238 of the waterway support 210. The spray plate 206 includes a second boss 215 that extends axially away from the spray plate 206 (e.g., a panel portion of the spray plate, etc.) at a central position along the spray plate 206. The second boss 215 is sized to be received within the first boss 214 and nestably engage (e.g., nest within) the first boss 214, which can facilitate alignment of the spray plate 206 with other components of the showerhead assembly 200. The showerhead assembly 200 also includes a fastener 218 (e.g., a screw, a bolt, a clip, etc.) that engages the first boss 214 and the second boss 215, and couples the first boss 214 to the second boss 215. In some embodiments, the fastener 218 is configured to threadably engage the second boss 215 and to draw the central portion of the spray plate 206 toward the waterway support 210. The boss arrangement also reduces the risk of the spray plate 206 becoming inadvertently dislodged from the showerhead assembly 200. In other embodiments, the fastener 218 may be replaced with a center clip or another type of mechanical fastener and/or connection.

In the embodiment of FIG. 7A, the nozzle mat 208 defines a central opening therethrough that is configured to receive the fastener 218 therein. The nozzle mat 208 also includes an inner seal member 211 that extends axially away from the nozzle mat 208 along a perimeter of the central opening. The inner seal member 211 is receivable within a corresponding groove of the first boss 214 to sealingly engage the nozzle mat 208 with the waterway support 210 (in addition to the outer seal member as described with reference to FIG. 4 above).

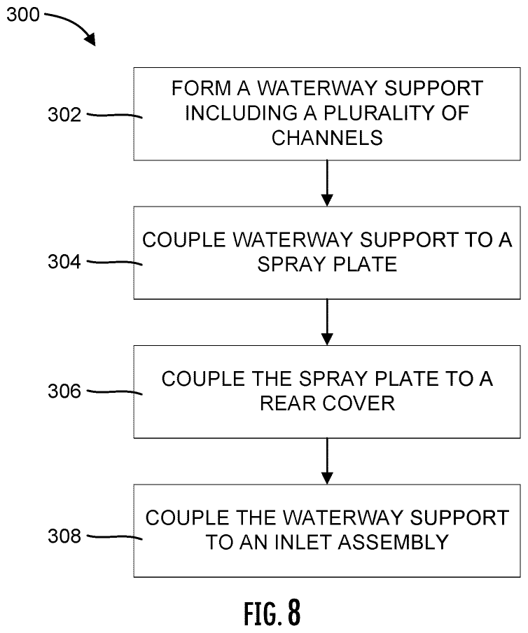

Referring to FIG. 8, a method 300 of making a showerhead assembly, such as the showerhead assembly 100 described with reference to FIGS. 1-6, or the showerhead assembly 200 described with reference to FIGS. 7A and 7B is shown, according to an embodiment.

In some embodiments, the method 300 includes coupling a waterway support (e.g., the waterway support 110 of FIG. 5) defining a central opening and a plurality of channels extending away from the central opening in a substantially radial direction to a spray plate (e.g., the spray plate 106 of FIG. 6) defining a plurality of openings therethrough such that at least one channel of the plurality of channels extends in a region of the spray plate that corresponds to a greatest distance between the central opening and an outermost one of the plurality of openings along the spray plate.

Referring to FIG. 8, in some embodiments, the method 300 includes forming a waterway support (e.g., the waterway support 110 of FIG. 5) including a plurality of channels (e.g., the channels 158), at operation 302. In some embodiments, operation 302 includes forming a waterway panel defining a central opening and channels that extend away from the central opening in a substantially radial direction. Operation 302 may include forming recessed areas (e.g., grooves, cutouts, etc.) in the waterway panel to form the channels. For example, operation 302 may include forming recessed areas in a region of the waterway panel corresponding to a greatest distance between the central opening and an outer perimeter of the waterway panel (e.g., between the central opening and a corner region of the waterway panel). The waterway panel may be formed from plastic via an injection molding operation. In other embodiments, operation 302 includes machining channels (e.g., recessed slots, passages, etc.) into the waterway panel.

In some embodiments, operation 302 also includes forming a plurality of flow directing members (e.g., the ribs 140 of FIG. 6, the first set of ribs 152, the second set of ribs 154, and/or the third set of ribs 156) onto the waterway panel. Operation 302 may include forming a pair of ribs onto opposing sides of at least one of the plurality of channels. In some embodiments, operation 302 includes forming the pair of ribs from the central opening along only a portion of a total length of the at least one channel. In some embodiments, operation 302 includes integrally forming the ribs with the waterway panel as a monolithic body from a single piece of material (e.g., by an injection molding and/or a machining operation, etc.).

Operation 304 includes coupling the waterway support to a spray plate. In some embodiments, operation 304 includes aligning the waterway support with the spray plate so that the channels face toward the spray plate or are otherwise disposed between a waterway panel of the waterway support and the spray plate. In some embodiments, operation 304 also includes engaging a plurality of waterway support clips of the waterway support with a lower set of latches on the spray plate.

In some embodiments, operation 304 includes positioning a nozzle mat that includes a plurality of nozzles between the waterway support and the spray plate. In such embodiments, operation 304 may include inserting the plurality of nozzles of the nozzle mat into openings that extend across the spray plate, and pressing the waterway support toward the spray plate to engage the ribs of the waterway support with the nozzle mat to secure the nozzle mat in position relative to the spray plate. In some embodiments, operation 304 includes engaging ribs of the waterway support that extend from edges of the at least one channel with the nozzle mat. In some embodiments, operation 304 also includes coupling the waterway support to the spray plate using a center boss fastener, as described above with respect to FIG. 7A.

Operation 306 includes coupling the spray plate to a rear cover. In some embodiments, operation 306 includes engaging a plurality of clips of the rear cover with an upper set of latches on the spray plate. Operation 306 may include pressing the rear cover toward the waterway support.

Operation 308 includes coupling the waterway support to an inlet assembly. In some embodiments, operation 308 includes inserting a ball joint connector that defines a venturi within at least a portion of an inlet connector that extends from the waterway panel. Operation 308 may include threadably engaging the inlet connector with a ball joint cover to secure the ball joint connector in position between the ball joint cover and the waterway panel.

The showerhead assembly disclosed herein provides several advantages over existing devices. The showerhead assembly includes an air induction device (e.g., a ball joint connector) that is configured to aerate water passing through the device and to inflate the size of water droplets distributed from the device. The showerhead assembly also includes a waterway support defining ribs and channels in an arrangement that can increase flow uniformity across the showerhead assembly. The channels in the waterway support are structured to deliver water to the outermost regions of the showerhead assembly and to provide a more uniform pressure drop between each of the nozzles of the showerhead assembly. In some embodiments, the showerhead assembly also includes a unique arrangement of nozzles that provides areas of higher flow concentration without reducing the total amount of spray coverage provided to a user. Together, these elements enable greater showering performance at reduced flowrates relative to conventional designs.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members, or the two members and any additional intermediate members being integrally formed as a single unitary body with one another, or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the apparatus and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A showerhead assembly comprising:
a spray plate defining a plurality of openings extending therethrough; and
a waterway support coupled to the spray plate, the waterway support defining:
a central opening; and
a plurality of channels extending away from the central opening in a substantially radial direction, at least one channel of the plurality of channels extending in a region of the spray plate corresponding to a greatest distance between the central opening and an outermost one of the plurality of openings along the spray plate.

2. The showerhead assembly of claim 1, wherein the waterway support defines at least a portion an internal waterway that is configured to direct water received through the central opening across the spray plate to the plurality of openings.

3. The showerhead assembly of claim 1, wherein the waterway support comprises:
a waterway panel; and
a plurality of ribs extending from the waterway panel substantially normal to the waterway panel.

4. The showerhead assembly of claim 1, wherein the waterway support comprises a waterway panel, and wherein the waterway panel defines a depression in an outer surface thereof that at least partially defines at least one of the plurality of channels.

5. The showerhead assembly of claim 1, wherein the waterway support comprises a waterway panel, and wherein an axial distance between the spray plate and the waterway panel at the at least one channel is greater than an average axial distance between the waterway panel and the spray plate.

6. The showerhead assembly of claim 1, wherein the waterway support comprises:
a waterway panel that defines the at least one channel of the plurality of channels; and
a pair of ribs extending from the waterway panel substantially normal to the waterway panel, the pair of ribs including a first rib and a second rib that extend along opposing sides of the at least one channel.

7. The showerhead assembly of claim 1, wherein the at least one channel of the plurality of channels extends toward a corner region of the spray plate.

8. The showerhead assembly of claim 1, wherein the waterway support further comprises substantially linear ribs that extend between adjacent openings of the spray plate.

9. The showerhead assembly of claim 1, wherein the waterway support comprises a first boss disposed at a central position across the waterway support, the spray plate comprises a second boss configured to nest within the first boss, and the showerhead assembly further comprises a fastener configured to couple the first boss to the second boss.

10. A waterway support for a showerhead assembly, the waterway support comprising:
an inlet connector defining a central opening; and
a waterway panel coupled to the inlet connector, the waterway panel defining a plurality of channels extending away from the central opening in a substantially radial direction, at least one channel of the plurality of channels extending in a region of the waterway panel between the central opening and a corner region of the waterway panel.

11. The waterway support of claim 10, further comprising a first set of ribs extending from the waterway panel substantially normal to the waterway panel, the first set of ribs including a first rib and a second rib that extend along opposing sides of the at least one channel.

12. The waterway support of claim 11, wherein the first rib and the second rib extends from an edge of the waterway panel at the central opening.

13. The waterway support of claim 11, wherein a length of at least one rib of the first set of ribs is less than a length of the at least one channel.

14. The waterway support of claim 11, further comprising a second set of ribs that extend linearly away from the central opening, wherein the first set of ribs extend at an angle relative to the second set of ribs.

15. The waterway support of claim 10, wherein the waterway panel defines a depression in an outer surface thereof that at least partially defines at least one of the plurality of channels.

16. The waterway support of claim 10, wherein a distal end of the at least one channel is disposed in the corner region of the waterway panel.

17. The waterway support of claim 10, wherein the waterway support comprises a boss disposed at a central position across the waterway panel, and a plurality of extensions that extend radially between the boss and the inlet connector.

18. A method comprising:
coupling a waterway support defining a central opening and a plurality of channels extending away from the central opening a substantially radial direction to a spray plate defining a plurality of openings therethrough such that at least one channel of the plurality of channels extends in a region of the spray plate that corresponds to a greatest distance between the central opening and an outermost one of the plurality of openings along the spray plate.

19. The method of claim 18, further comprising forming the waterway support by forming a waterway panel defining the central opening and the plurality of channels extending away from the central opening in the substantially radial direction, such that the at least one channel of the plurality of channels extends in a region of the waterway panel between the central opening and a corner region of the waterway panel.

20. The method of claim 18, further comprising positioning a nozzle mat that includes a plurality of nozzles between the waterway support and the spray plate, wherein coupling the waterway support to the spray plate comprises engaging ribs of the waterway support that extend from edges of the at least one channel with the nozzle mat.
